(19) United States
(12) Patent Application Publication
(10) Pub. No.: US 2016/0328350 A1
(43) Pub. Date: Nov. 10, 2016

(54) RESTART SYSTEM AND MOTHERBOARD THEREOF

(71) Applicants: HONG FU JIN PRECISION INDUSTRY (ShenZhen) CO., LTD., ShenZhen (CN); HON HAI PRECISION INDUSTRY CO., LTD., New Taipei (TW)

(72) Inventor: MENG-LIANG YANG, Shenzhen (CN)

(21) Appl. No.: 14/750,458

(22) Filed: Jun. 25, 2015

(30) Foreign Application Priority Data
May 8, 2015 (CN) 201510231568.9

(51) Int. Cl. G06F 13/40; G06F 13/42; G06F 1/26; G06F 13/362

(52) U.S. Cl. CPC G06F 13/4081; G06F 13/362; G06F 13/4027; G06F 13/4282; G06F 1/266

(57) ABSTRACT

A restart system includes a control device and an electronic device. The electronic device includes a motherboard and a PCI Express device. The motherboard includes a control chip, a PCI Express slot and a hot-swap chip. When the motherboard does not identify the PCI Express device electrically coupled to the PCI Express slot, the control device outputs a signal to the control chip. The control chip outputs a first control signal to the hot-swap chip and outputs a second control signal to the PCI Express device. After receiving the first control signal, the hot-swap chip is restarted. In restarting of the hot-swap chip, when the hot-swap chip is powered off, the hot-swap chip does not power the PCI Express device, and when the hot-swap chip is powered on, the hot-swap chip powers the PCI Express device. After receiving the second control signal, the PCI Express device is restarted.

### FIELD

The subject matter herein generally relates to restart systems and particularly to a restart system to restart hot-swap devices.

### BACKGROUND

Hot-swap is a useful function of replacing or restarting electronic elements of a computer system, such as a server or a computer, without shutting down the computer system. However, when an electronic element, such as hard disk drive, received in a chassis of the computer system needs to be replaced or restarted through hot-swap, the chassis needs to be opened.

### BRIEF DESCRIPTION OF THE DRAWINGS

Implementations of the present technology will now be described, by way of example only, with reference to the attached figures.

FIG. 1 is a block diagram of an embodiment of a restart system.

FIG. 2 is a circuit diagram of the restart system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure relates to a restart system to restart hot-swap devices.

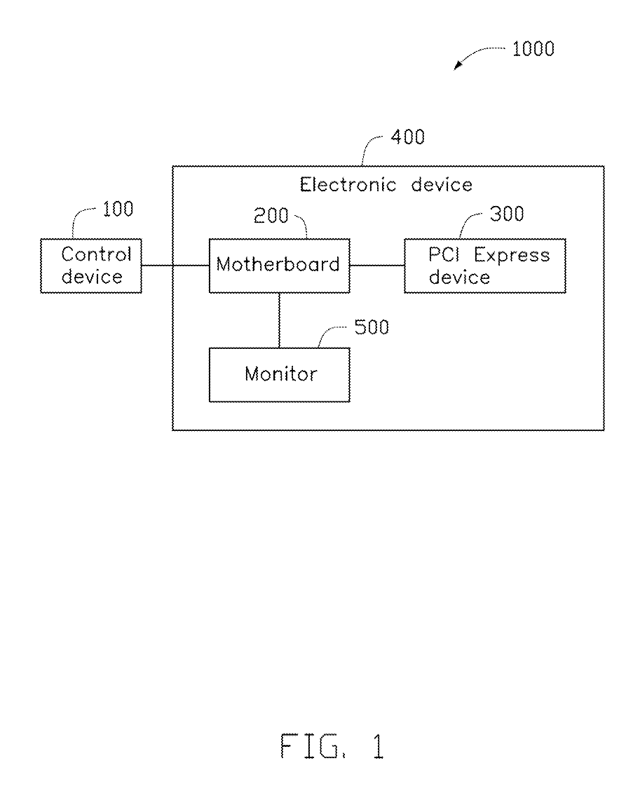

FIG. 1 illustrates an exemplary embodiment of a restart system 1000. The restart system 1000 can comprise a control device 100 and an electronic device 400. The electronic device 400 can comprise a motherboard 200, a peripheral component interconnect (PCI) Express device 300, and a monitor 500. The motherboard 200 is electrically coupled to the control device 100 and the PCI Express device 300, and electrically coupled to the monitor 500. The PCI Express device 300 can be restarted without plugging the PCI Express device 300 through cooperation of the control device 100 and the motherboard 200. The control device 100 can control the electronic device 400. The monitor 500 can display whether the motherboard 200 identifies the PCI Express device 300 electrically coupled to the motherboard 200. In at least one embodiment, the electronic device 400 can be a computer, a server or a data center.

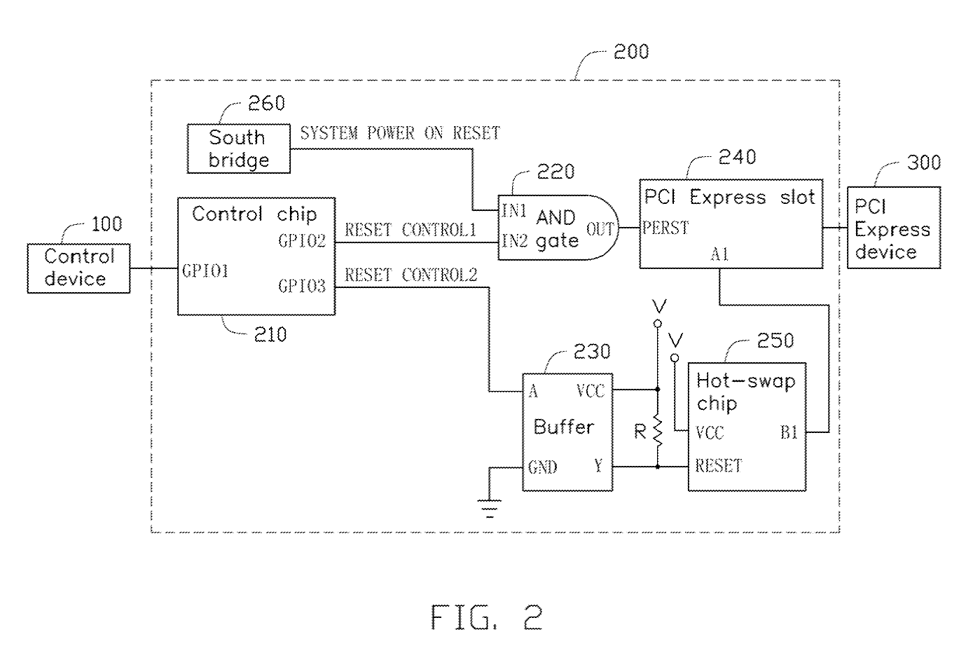

FIG. 2 illustrates an embodiment of the motherboard 200. The motherboard 200 can comprise a control chip 210, an AND gate 220, a buffer 230, a PCI Express slot 240, a hot-swap chip 250 and a south bridge 260. The control chip 210 can comprise an input pin GPIO1 and two output pin GPIO2 and GPIO3. The AND gate 220 can comprise a first input terminal IN1, a second input terminal IN2 and an output terminal OUT. The buffer 230 can comprise an input pin A, a ground pin GND, a power supply pin VCC, and an output pin Y. The PCI Express slot 240 can comprise a power supply pin A1 and a reset pin PERST. The hot-swap chip 250 can comprise a power supply pin VCC, a power supply output pin B1, and a reset pin RESET. The input pin GPIO1 of the control chip 210 is electrically coupled to the control device 100. The output pin GPIO2 of the control chip 210 is electrically coupled to the second input terminal IN2 of the AND gate 220, and the output pin GPIO3 of the control chip 210 is electrically coupled to the input pin A of the buffer 230. The first input terminal IN1 of the AND gate 220 is electrically coupled to the south bridge 260, and the output terminal OUT of the AND gate 220 is electrically coupled to the reset pin PERST of the PCI Express slot 240. The ground pin GND of the buffer 230 is electrically coupled to a ground. The power supply pin VCC of the buffer 230 is electrically coupled to a power supply V. The output pin Y of the buffer 230 is electrically coupled to the reset pin RESET of the hot-swap chip 250, and electrically coupled to the power supply V through a resistor R. The power supply pin A1 of the PCI Express slot 240 is electrically coupled to the power supply output pin B1 of the hot-swap chip 250. The PCI Express slot 240 is electrically coupled to the PCI Express device 300.

In at least one embodiment, the control chip 210 can be an Integrated Baseboard Management Controller (IBMC), and the hot-swap chip 250 can be a dual channel hot-swap controller. The hot-swap chip 250 is configured to output power received from the motherboard 200 to the PCI Express device 300 through the PCI Express slot 240.

When the electronic device 400 is powered on, the south bridge 260 outputs a low level signal SYSTEM ON POWER RESET to the first input terminal IN1 of the AND gate 220. The output terminal OUT of the AND gate 220 outputs a low level signal to the reset pin PERST of the PCI Express slot 240, and the PCI Express device 300 electrically coupled to the PCI Express slot 240 is restarted. After the electronic device 400 is powered on, the south bridge 260 does not output the low level signal SYSTEM ON POWER RESET.

After the electronic device 400 is powered on, a device manager of the electronic device 400 is opened, and information of the device manager is displayed on the monitor 500. When the information in the monitor 500 shows that the motherboard 200 does not identify the PCI Express device 300 electrically coupled to the PCI Express slot 240, a command is input to the control device 100, and the control device 100 outputs a signal to the input pin GPIO1 of the control chip 210. After the control chip 210 receives the signal, the output pin GPIO2 of the control chip 210 outputs a low level signal RESET CONTROL1 to the second input terminal IN2 of the AND gate 220, and the output pin GPIO3 of the control chip 210 outputs a low level signal RESET CONTROL2 to the input pin A of the buffer 230. The output pin Y of the buffer 230 outputs the low level signal RESET CONTROL2 received from the input pin A of the buffer 230 to the reset pin RESET of the hot-swap chip 250, and the hot-swap chip 250 is restarted. In restarting the hot-swap chip 250, when the hot-swap chip 250 is powered off, the hot-swap chip 250 does not provide power to the PCI Express slot 240, and the PCI Express device 300 is powered off, which is equivalent to pulling out the PCI Express device 300 from the PCI Express slot 240. When the hot-swap chip 250 is powered on, the hot-swap chip 250 provides power to the PCI Express slot 240, and the PCI Express device 300 is powered on, which is equivalent to inserting the PCI Express device 300 into the PCI Express slot 240. The output terminal OUT of the AND gate 220 outputs a low level signal to the reset pin PERST of the PCI Express slot 240 after the second terminal IN2 of the AND gate 220 receives the low level signal RESET CONTROL1, and the PCI Express device 300 is restarted. In other words, a restart of the PCI Express device 300 is equivalent to pulling out the PCI Express device 300 from the PCI Express slot 240 and inserting the PCI Express device 300 into the PCI Express slot 240.

When the information in the monitor 500 shows that the motherboard 200 identifies the PCI Express device 300 electrically coupled to the PCI Express slot 240, the command does not need to be input to the control device 100.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A restart system comprising:
a control device; and
an electronic device comprising:
a motherboard comprising a control chip, a PCI Express slot and a hot-swap chip; and
a PCI Express device;
wherein the control chip is electrically coupled to the control device, the PCI Express slot and the hot-swap chip, the PCI Express slot is electrically coupled to the PCI Express device and the hot-swap chip, and the hot-swap chip is configured to power the PCI Express device through the PCI Express slot;
wherein the motherboard is configured such that in event that the motherboard does not identify the PCI Express device electrically coupled to the PCI Express slot, the control device outputs a first signal to the control chip, and the control chip outputs a first control signal to the hot-swap chip and outputs a second control signal to the PCI Express device through the PCI Express slot;
wherein the hot-swap chip is configured such that after receiving the first control signal, the hot-swap chip is restarted, in restarting of the hot-swap chip, when the hot-swap chip is powered off, the hot-swap chip does not power the PCI Express device, and when the hot-swap chip is powered on, the hot-swap chip powers the PCI Express device; and
wherein the PCI Express device is configured such that after receiving the second control signal, the PCI Express device is restarted.

2. The restart system of claim 1, wherein the control chip comprises a first input pin, a first output pin and a second output pin, and the first input pin of the control chip is electrically coupled to the control device to receive the first signal.

3. The restart system of claim 2, the motherboard further comprises a buffer, the buffer comprises an input pin, an output pin and a power supply pin, the second output pin of the control chip is electrically coupled to the input pin of the buffer, the output pin of the buffer is electrically coupled to the hot-swap chip, the power supply pin of the buffer is electrically coupled to a power supply, and electrically coupled to the output pin of the buffer through a resistor, when the first input pin of the control chip receives the first signal, the second output pin of the control chip outputs the first control signal to the input pin of the buffer, the output pin of the buffer outputs the first control signal to the hot-swap chip, and the hot-swap chip is restarted.

4. The restart system of claim 3, wherein the motherboard further comprises an AND gate, the AND gate comprises a first input terminal, a second input terminal, and an output terminal, the first output pin of the control chip is electrically coupled to the second input terminal of the AND gate, the output terminal of the AND gate is electrically coupled to the PCI Express slot, when the first input pin of the control chip receives the first signal, the first output pin of the control chip outputs the second control signal to the second input terminal of the AND gate, the output terminal of the AND gate outputs the second control signal to the PCI Express slot, and the PCI Express device is restarted.

5. The restart system of claim 4, wherein the PCI Express slot comprises a power supply pin and a reset pin, the hot-swap chip comprises a power supply pin, a power supply output pin and a reset pin, the output terminal of the AND gate is electrically coupled to the reset pin of the PCI Express slot, the output pin of the buffer is electrically coupled to the reset pin of the hot-swap chip, the power supply pin of the hot-swap chip is electrically coupled to the power supply, the power supply output pin of the hot-swap chip is electrically coupled to the power supply pin of the PCI Express slot, the power supply output pin of the hot-swap chip outputs power to the PCI Express device through the power supply pin of the PCI Express slot, and when the reset pin of the hot-swap chip receives the first control signal, the hot-swap chip is restarted, and when the reset pin of the PCI Express slot receives the second control signal, the PCI Express device is restarted.

6. The restart system of claim 4, wherein the motherboard further comprises a south bridge, the first input terminal of the AND gate is electrically coupled to the south bridge, and the south bridge outputs a second signal to the first input terminal of the AND gate, in event that the motherboard is powered on.

7. The restart system of claim 1, wherein the control chip is an Integrated Baseboard Management Controller.

8. A motherboard comprising:
a control chip;
a PCI Express slot electrically coupled to the control chip, and electrically coupled to a PCI Express device; and
a hot-swap chip electrically coupled to the control chip, and electrically coupled to the PCI Express slot and configured to provide power to the PCI Express device;
wherein the motherboard is configured such that in event that the motherboard does not identify the PCI Express device electrically coupled to the PCI Express slot, a control device outputs a first signal to the control chip, and the control chip outputs a first control signal to the hot-swap chip and outputs a second control signal to the PCI Express device through the PCI Express slot;
wherein the hot-swap chip is configured such that after receiving the first control signal, the hot-swap chip is restarted, in restarting of the hot-swap chip, when the hot-swap chip is powered off, the hot-swap chip does not power the PCI Express device, and when the hot-swap chip is powered on, the hot-swap chip powers the PCI Express device; and
wherein the PCI Express device is configured such that after receiving the second control signal, the PCI Express device is restarted.

9. The motherboard of claim 8, wherein the control chip comprises a first input pin, a first output pin and a second output pin, and the first input pin of the control chip is electrically coupled to the control device to receive the first signal.

10. The motherboard of claim 9, the motherboard further comprises a buffer, the buffer comprises an input pin, an output pin and a power supply pin, the second output pin of the control chip is electrically coupled to the input pin of the buffer, the output pin of the buffer is electrically coupled to the hot-swap chip, the power supply pin of the buffer is electrically coupled to a power supply, and electrically coupled to the output pin of the buffer through a resistor, when the first input pin of the control chip receives the first signal, the second output pin of the control chip outputs the first control signal to the input pin of the buffer, the output pin of the buffer outputs the first control signal to the hot-swap chip, and the hot-swap chip is restarted.

11. The motherboard of claim 10, wherein the motherboard further comprises an AND gate, the AND gate comprises a first input terminal, a second input terminal, and an output terminal, the first output pin of the control chip is electrically coupled to the second input terminal of the AND gate, the output terminal of the AND gate is electrically coupled to the PCI Express slot, when the first input pin of the control chip receives the first signal, the first output pin of the control chip outputs the second control signal to the second input terminal of the AND gate, the output terminal of the AND gate outputs the second control signal to the PCI Express slot, and the PCI Express device is restarted.

12. The motherboard of claim 11, wherein the PCI Express slot comprises a power supply pin and a reset pin, the hot-swap chip comprises a power supply pin, a power supply output pin and a reset pin, the output terminal of the AND gate is electrically coupled to the reset pin of the PCI Express slot, the output pin of the buffer is electrically coupled to the reset pin of the hot-swap chip, the power supply pin of the hot-swap chip is electrically coupled to the power supply, the power supply output pin of the hot-swap chip is electrically coupled to the power supply pin of the PCI Express slot, the power supply output pin of the hot-swap chip outputs power to the PCI Express device through the power supply pin of the PCI Express slot, and when the reset pin of the hot-swap chip receives the first control signal, the hot-swap chip is restarted, and when the reset pin of the PCI Express slot receives the second control signal, the PCI Express device is restarted.

13. The motherboard of claim 11, wherein the motherboard further comprises a south bridge, the first input terminal of the AND gate is electrically coupled to the south bridge, and the south bridge outputs a second control signal to the first input terminal of the AND gate, in event that the motherboard is powered on.

14. The motherboard of claim 8, wherein the control chip is an Integrated Baseboard Management Controller.
